(19) United States
(12) Patent Application Publication
(10) Pub. No.: US 2025/0377518 A1
(43) Pub. Date: Dec. 11, 2025

(54) Mount For An Optical Element

(71) Applicant: II-VI Delaware, Inc., Wilmington, DE (US)

(72) Inventors: Daniel Labahn, Wilmington, DE (US); Patrick Kuehl, Wimington, DE (US); Gunnar Koehler, Wilmington, DE (US)

(21) Appl. No.: 18/776,564

(22) Filed: Jul. 18, 2024

(30) Foreign Application Priority Data
Jun. 11, 2024 (DE) 10 2024 116 240.6

(51) Int. Cl. G02B 7/02

(52) U.S. Cl. CPC G02B 7/021

(57) ABSTRACT

The present disclosure relates to a mount for an optical element for disposal, comprising an edge having an opening configured such that an optical element can be radially inserted into the mount. A first system may comprise the mount and an optical element for insertion into the mount, and a second system may comprise the first system and a device for receiving the mount. A laser processing head for laser material processing may comprise the second system.

### CROSS-REFERENCE TO RELATED APPLICATIONS

The present invention claims priority to national German patent application no. DE 10 2024 116 240.6 filed on Jun. 11, 2024. The aforementioned application is hereby incorporated herein by reference in its entirety.

### FIELD OF THE DISCLOSURE

The present disclosure relates generally to a system with a mounting structure for optical elements.

### BACKGROUND OF THE DISCLOSURE

Lasers, laser processing heads and systems, components and accessories for these as well as laser measuring instruments are generally known in the art. The laser processing heads and systems are designed for processing materials, including welding, soldering and cutting.

Laser processing heads and systems comprise a large number of optical elements. For beam shaping, laser processing systems use lenses, for example, which collimate or focus the laser beam. The optical elements are usually arranged in groups along the optical axis and are combined in so-called tubes. Entire groups of optical elements can often be exchanged as required, rather than having to replace a large number of individual elements.

For the optical elements, it is important that they are fixed in the intended position. Even minimal changes to the position, for example centering, have an influence on the function of the respective optical element, for example during beam shaping. This is another reason why it is advantageous to combine groups of optical elements into units.

The optical elements are replaced in a device depending on the required imaging properties. Replacement may also be necessary if optical elements are dirty or damaged. The aforementioned importance of the correct positioning and stacking of the optical elements means that replacing them is often time-consuming. In the field of laser material processing, it is then necessary to dismantle the so-called laser material processing head. Opening an optical device always involves the risk of introducing dirt or contamination. There is also a risk of damage to optical elements, for example if they are stacked.

Mounting rings for optical elements are known from the state of the art, as described in DE 753 663, for example. These are metal rings that are fitted around the optical element like a mount. A disadvantage of the solutions known from the prior art is the fixed connection of the mounts to the respective optical element, which can usually only be separated from each other again with considerable mechanical effort.

Furthermore, spacer rings, screw rings and resilient elements are still used in the state of the art, the force of which acts along the optical axis (Vukobratovich et al, Fundamentals of Optomechanics, Taylor & Francis Group, 2018).

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The present disclosure provides a mount for optical elements which provides a fixed but easily reversible connection between the optical element and the mount in order to reduce the time required to change optical elements and the risk of contamination and damage.

These and other advantages, aspects and novel features of the present disclosure, as well as details of an illustrated embodiment thereof, will be more fully understood from the following description and drawings.

### BRIEF DESCRIPTION OF THE DRAWINGS

The disclosure is illustrated in more detail below with reference to drawings. It is obvious to the person skilled in the art that these are only possible, example embodiments, without the disclosure being necessarily limited to the embodiments shown, wherein:

FIG. 1A shows an optical element and mount according to the present disclosure separately from each other an optical element arranged in a mount according to an example embodiment of the present the disclosure;

FIG. 1B shows the optical element of FIG. 1A inserted into the mount according to an example embodiment of the present disclosure;

FIG. 1C shows the optical element of FIGS. 1A and 1B fixed but reversibly arranged in the mount according to an example embodiment of the present disclosure.

FIG. 2 shows a cross-section through an optical element which is arranged in a mount according to an example embodiment the present disclosure.

FIG. 3 shows an example embodiment with a fixed contour and a spring element for fixing the optical element.

FIG. 4 shows an example embodiment with two spring elements for fastening the optical element.

FIG. 5. shows an example embodiment with a fixed contour and a counter-contour for fixing the optical element.

FIG. 6-FIG. 9 show differently shaped contours for positioning and fixing the optical element, according to various example embodiments of the present disclosure.

FIG. 10A and FIG. 10B show differently shaped contours for positioning and fixing the optical element in the z-axis, according to various example embodiments of the present disclosure.

FIG. 11A-C show rectangular example embodiments of the optical element.

FIG. 12A-D show elliptical example embodiments of the optical element.

FIG. 13 shows right-angled, U-shaped and C-shaped contours, according to various example embodiments of the present disclosure.

FIG. 14 shows a mounted optical element, according to an example embodiment of the present disclosure.

FIG. 15A-E shows various example embodiments of a sliding support surface.

FIG. 16 shows an image for an optical element, according to an example embodiment of the present disclosure.

FIG. 17 shows the mount from FIG. 16 in a housing, according to an example embodiment of the present disclosure.

FIG. 18 shows the arrangement of optical elements in a tube, according to an example embodiment of the present disclosure.

FIG. 19 shows a laser processing head in which optical elements are arranged by means of mounts, according to an example embodiment of the present disclosure.

### DETAILED DESCRIPTION OF THE DISCLOSURE

The present disclosure provides a mount for optical elements which provides a fixed but easily reversible connection between the optical element and the mount in order to reduce the time required to change optical elements and the risk of contamination and damage. The mount for an optical element may comprise a rim having an opening configured such that an optical element can be radially inserted into the mount.

For the purposes of the present disclosure, optical elements are to be understood as lenses, protective glasses, mirrors and beam shaping elements. The term fixation in connection with an optical element comprises the centering and positioning of the optical element in the beam path.

For the purposes of the present disclosure, the z-direction is to be understood as the direction along the optical axis, i.e. from the light source to the exit aperture. The x- and y-directions denote the axes transverse to the optical axis of the beam path from the light source to the exit aperture of an optical device.

The mount according to the present disclosure is intended for use in laser processing systems in which so-called high-power lasers are used.

The mount according to an example embodiment of the present disclosure does not completely enclose the optical element, but only for the most part. The mount thus has an interruption, which can also be referred to as an opening. The optical element is inserted into or removed from the mount through this opening.

In cross-section, the mount according to an example embodiment of the present disclosure has a U- or C-shaped profile, which ensures that the optical element is held in the mount and cannot be displaced in the beam direction in the mount. Such a U- or C-shaped notch may have further contours to increase the area with which the edge of the optical element and the mount interact.

In addition, the open ends of the mount have radially acting elements which fix the optical element firmly but reversibly in the mount. The radially acting elements are contours such as wedges, half shells, stops, balls and the like, which close the opening of the U- or C-shaped profile by means of a radially acting spring tension and/or screw tension. By pushing back the radially acting elements, the optical element can be inserted into or removed from the profile of the mount.

Alternatively, the open mount can be designed in such a way that it is itself resilient and thus holds the optical element with a larger circumference. In one embodiment, the mount can consist of several parts, also to make it resilient.

The mount can also have sliding elements that facilitate the insertion of the optical element. It is intended that these are made of polyamide, polytetrafluoroethylene or polyethylene, for example.

The mount can have a round or angular shape in relation to the part enclosing the optical element, which is open at one point and therefore does not completely enclose the optical element.

According to example embodiments of the present disclosure, the described mount is coded or asymmetrical in cross-section to prevent incorrect orientation of the optical element in the mount.

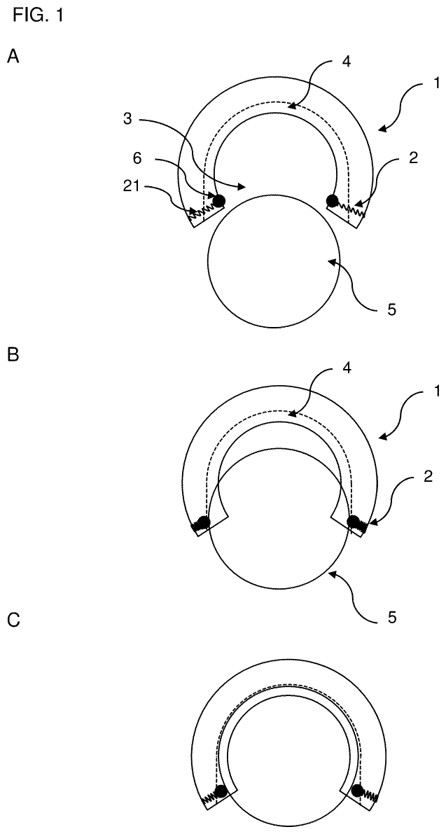

FIG. 1A shows a top view of a mount 1 according to the present disclosure. In the example embodiments shown in FIG. 1A-C, the mount 1 is round and surrounds the optical element 5 by more than 180°, but not completely.

The optical element 5 is inserted into the mount 1 via the opening 3. The inner contour 4 is indicated by the dashed line in the top view. This corresponds to the outer contour of the optical element 5 and therefore fits snugly against the outer contour of the optical element.

FIG. 1B shows how the optical element 5 engages in the inner contour 4 of the mount 1 and is thus secured against slipping or movement in the direction of the beam. This compresses the radially acting elements 2 (see FIG. 1A and FIG. 1B).

FIG. 1A clearly shows that the radially acting elements 2 consist of a spring part 21 and a contour 6.

FIG. 1C shows an optical element 5 arranged completely in the mount 1. The radially acting elements 2 exert pressure on the edge of the optical element 5 and thus fix it in the mount 1. As a result, the optical element 5 is prevented from moving in all three dimensions in relation to the mount 1. Mount 1 can now be arranged and fixed in the beam path of an optical arrangement, for example in a laser processing head. For this purpose, mount 1 can also be arranged or inserted in a so-called lens tube. According to the invention, however, it is also expressly provided that a mount according to the present disclosure can be exchanged individually from the outside with the optical element arranged therein or that the mount 1 is permanently installed in a processing head in order to exchange only the optical element individually.

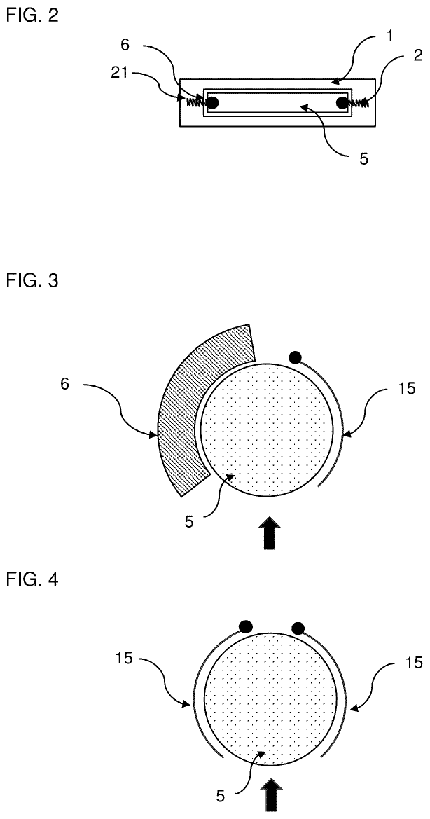

FIG. 2 shows a cross-section of a mount 1 with an optical element 5 arranged therein. Mount 2, consisting of a spring part 21 and a contour 6, secures the optical element in a secure seat in mount 1, according to an example embodiment of the present disclosure.

FIG. 3 shows an example embodiment with a fixed contour 6 and a spring element 15 for fixing the optical element 5. The optical element 5 is held in place by a fixed contour 6 being arranged on one side and a spring element 15, which applies a radial force, being arranged on the other side. The arrow indicates the insertion direction of the optical element 5.

FIG. 4 shows an example embodiment with two spring elements 15 for fastening the optical element. The optical element 5 is held in place by two spring elements 15 applying a radial force in the direction of the optical element. The arrow indicates the insertion direction of the optical element 5.

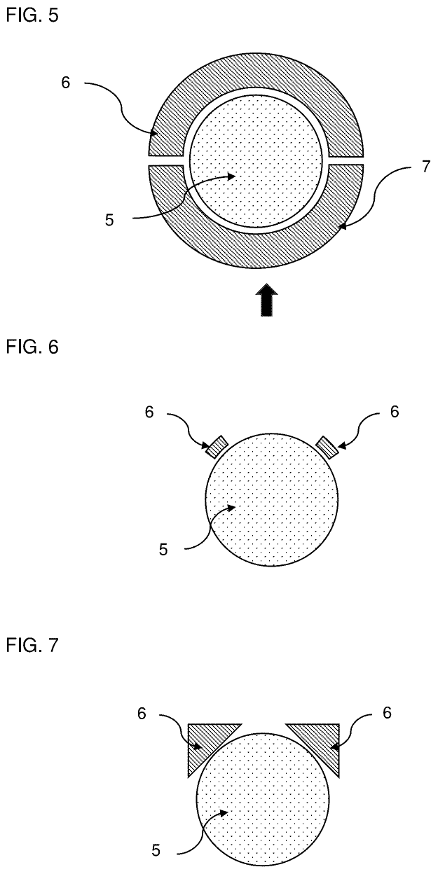

FIG. 5. shows an example embodiment with a fixed contour 6 and a counter-contour 7 for fastening the optical element 5. The optical element 5 is held by a fixed contour 6 being arranged in the mount on one side and a counter-contour 7 being attached from the opposite side and thus applying a force for clamping in the direction of the fixed contour 6. The arrow indicates the insertion direction of the optical element 5.

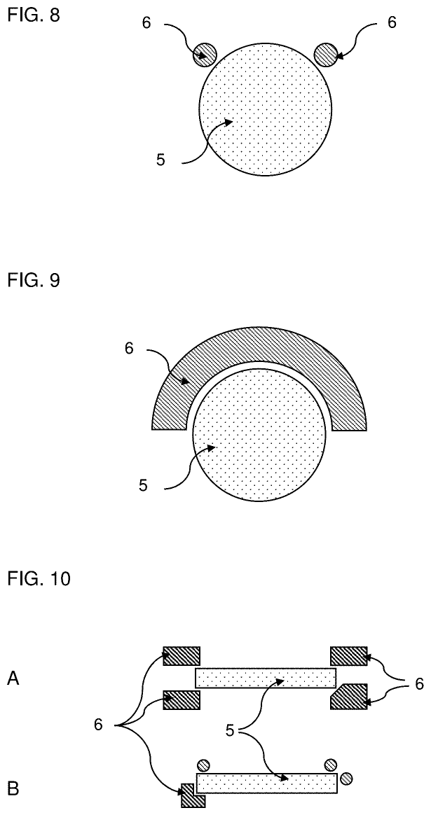

FIG. 6-FIG. 9 show differently shaped contours 6 for positioning and fixing the optical element 5, according to various example embodiments of the present disclosure. Two or three support or contact points are required for fixing the optical element 5 in the mount, as well as a force acting in their direction. FIGS. 6-9 show contours which are designed as stops (FIG. 6), wedges (FIG. 7), spheres or cylinders (FIG. 8) or half-shells (FIG. 9).

FIG. 10A and FIG. 10B show differently shaped contours 6 for positioning and fixing the optical element 5 in the z-axis which are designed as stops, wedges, spheres or cylinders or half shells, according to various example embodiments of the present disclosure.

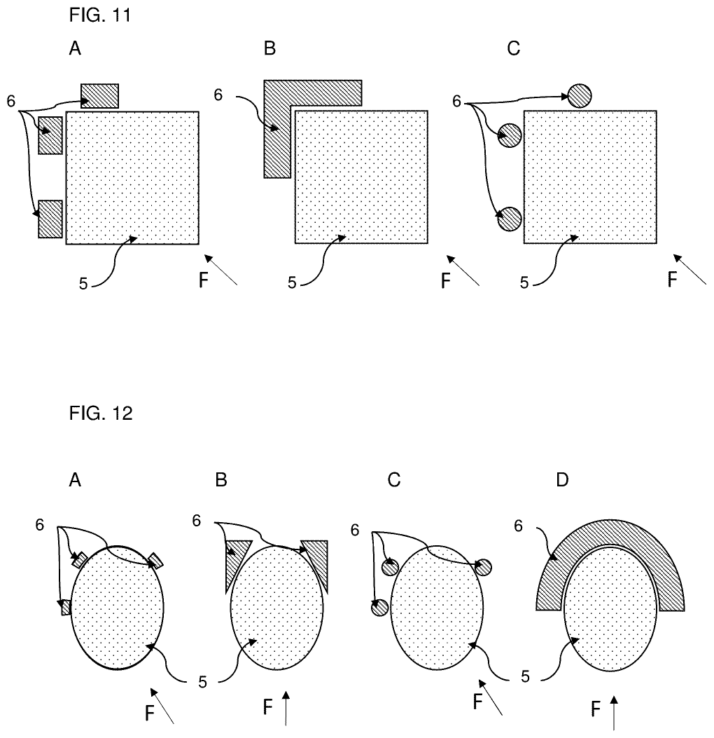

FIGS. 11A-C show rectangular example embodiments of the optical element 5. The contours 6 are rectangular (FIG. 11A), angular (FIG. 11B) or circular (FIG. 11C).

FIGS. 12A-D show elliptical example embodiments of the optical element 5. The contours 6 are circular as a stop (FIG. 12A), as wedges (FIG. 12B), as spheres or cylinders (FIG. 12C) or semi-elliptical (FIG. 12D).

The arrows in FIGS. 11A-C and 12A-D indicate the direction of the force F which acts here to fix the optical elements 5 in the mount using, for example, radially acting spring elements (not shown) or other contours to be fixed (not shown).

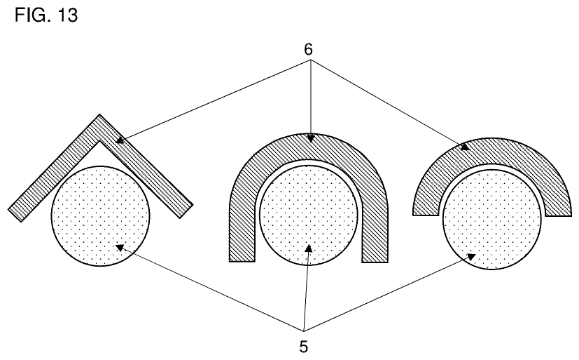

FIG. 13 shows right-angled U- and C-shaped contours 6 for fixing the optical element 5, according to an example embodiment of the present disclosure.

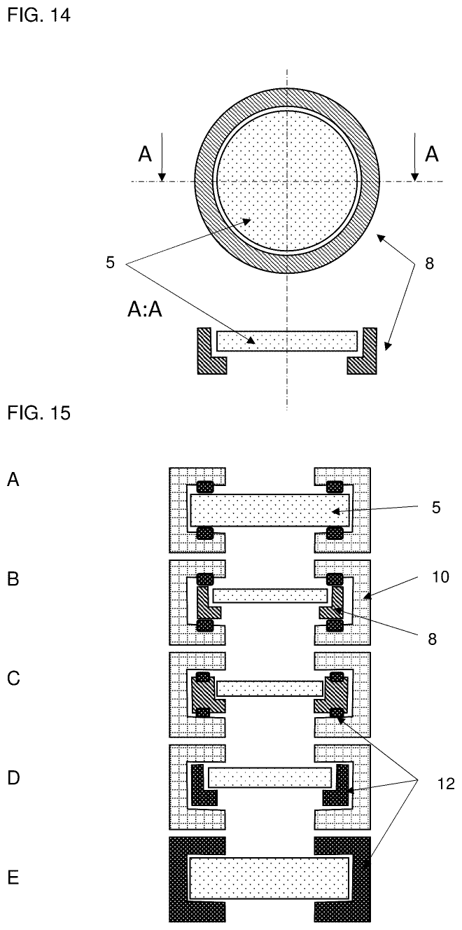

FIG. 14 shows a mounted optical element 5 in two planes, according to an example embodiment of the present disclosure. The optical element 5 can be fixed in the socket 8 by gluing, a threaded ring 23, clamping screws or clamping caps or by positive locking, for example a snap hook in the case of an elastic mount 8.

FIG. 15 shows various example embodiments of sliding elements 12. The sliding properties of the sliding elements can be integrated into the various elements of the system. For example, there are dedicated sliding elements in the seat 10 or mount 8. In one embodiment, the socket 8 itself is made of a sliding material. The seat 10 or a contour (not shown) itself is made of a sliding material. Example embodiments include a sliding element in seat 10 with optical element 5, sliding element in seat 10 with mounted optical element 5, sliding elements 12 integrated in mount 8, a socket 8 made of a slidable material and a seat 10 made of a slidable material (compatible with mounted and unmounted optical elements 5).

FIG. 16 shows a seat 10 for an optical element 5 with and without mount, according to example embodiments of the present disclosure.

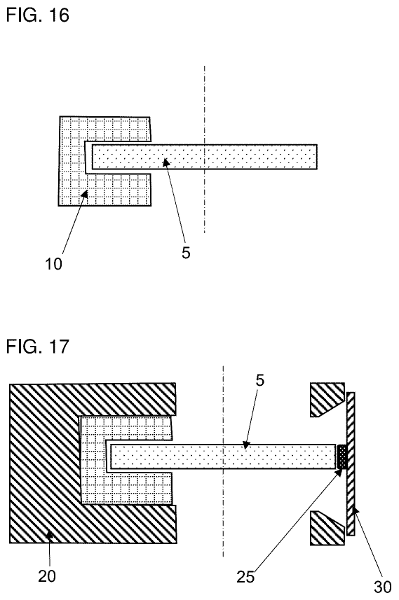

FIG. 17 shows the seat 10 of FIG. 16 in a housing 20 with a cover 30 as a closure, according to an example embodiment of the present disclosure. Cover 30 has a push-on element 25. The cover 30 allows easy access to the optical element 5.

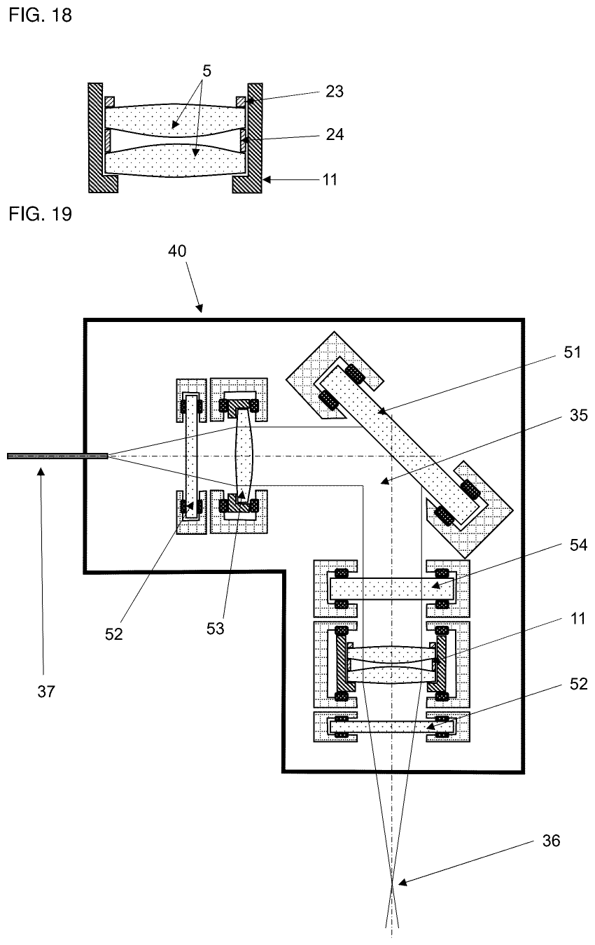

FIG. 18 shows the arrangement of optical elements 5 in a tube 11, according to an example embodiment of the present disclosure. In the example embodiment shown, a distance ring 24 is arranged between optical elements as a spacer. The optical elements 5 are fixed, for example, with a threaded ring 23.

FIG. 19 shows a laser processing head 40 in which optical elements 5 are arranged by means of mounts, according to an example embodiment of the present disclosure. Mirrors 51, protective glasses 52, lenses 53 and beam shapers 54 are arranged as optical elements in the laser processing head 40 shown as an example. The optical elements are in the beam path of the laser beam 35, which emerges from an optical fiber or an optical cable 37 and enters the laser processing head 40.

A tube 11 in which, for example, lenses are arranged (see FIG. 18) can also be arranged in the beam path of the laser beam 35. The optical elements in the laser processing head 40 generate a focus 36, which is used for laser material processing.

As a technical effect, the technical features of the present disclosure result in the fixed arrangement of an optical element in a mount, the connection between the optical element and the mount being fixed but reversible.

The described mount and an optical element form a first system, which can then be arranged or attached in a second system, for example a lens tube. The mount, first and second system can be used in a laser processing head for laser material processing.

Depending on the design, the mount can also be a fixed component of a unit or the laser processing head. In this case, the optical element is then correctly positioned by inserting it into the permanently installed mount in accordance with the disclosure. Alternatively, the optical element is fixed in the mount and this then brings the optical element into the intended position in the beam path by fixing it in an arrangement (second system).

A significant advantage of a mount according to the present disclosure is the possibility that each optical element can be replaced independently/individually, with or without the mount. It is possible to remove the optical element radially to the optical axis. A (partial) disassembly of the optics is avoided by using a mount according to the present disclosure. If the mount is permanently installed, only the optical element, possibly with mount or tube, needs to be replaced or touched for the purpose of replacement. Overall, the interaction time for replacing an optical element is reduced, which minimizes downtimes of devices and also reduces the risk of contamination. The solution to the technical problem according to the invention also enables the use of pre-centered or pre-calibrated optical elements to be exchanged in a mount according to the disclosure, which eliminates the need to calibrate the entire system. During replacement, the mount can serve as a contact point so that the optical element no longer needs to be touched. Thus, by avoiding contact with the optical element, the risk of contamination of the optical element or the introduction of contamination into an optical device such as a laser processing head is reduced.

A further advantage of a mount and its use in a system or laser processing head is the possibility of quickly changing the optics in terms of adapting their function, e.g. other focal lengths, other beam shapers, etc.

In one example embodiment of the mount according to the present disclosure, at least one radially acting element for fixing the optical element is arranged at the edge.

Furthermore, for example the radially acting element can be a spring element or a contour.

According to example embodiments of the present disclosure, it is also provided that the contours are selected from the group comprising wedges, half shells, stops and balls.

In one example embodiment of the mount according to the present disclosure, the edge has a notch for positioning the optical element in the Z-direction.

It is also intended, for example, that the edge surrounds the optical element in a ring or rectangular shape.

Furthermore, the notch is designed as a C- or U-shaped profile in example embodiments.

The spring part of the radially acting element may include shaped springs, strip springs, flat springs, leaf springs, spiral springs, barrel springs or ring springs.

In one example embodiment of the mount according to the present disclosure, the mount comprises contours in a C- or U-shaped profile to increase the contact area between the optical element and the mount.

A round mount is designed to enclose the optical element by, for example, 180° to 240°.

In one example embodiment, it is also provided that the mount has an asymmetrical shape in cross-section to accommodate the optical element.

Furthermore, in one example embodiment, the mount according to the present disclosure has sliding elements in order to facilitate the insertion of the optical element, wherein the sliding elements consist, for example, of polyamide, polytetrafluoroethylene or polyethylene.

Another example aspect of the present disclosure is a first system comprising a mount as described above and an optical element for insertion into the mount.

In one example embodiment, the optical element of a first system is surrounded by a frame.

A further aspect of the present disclosure is a second system comprising a first system as described above and a device for receiving the mount, where in one embodiment of the second system it is a lens tube.

Another aspect of the present disclosure is a laser processing head for laser material processing comprising a second system as described above.

Other aspects, features and advantages of the present disclosure will readily be apparent from the foregoing detailed description, which simply illustrates preferred embodiments and implementations. The present disclosure may also be realized in other and different embodiments and its various details may be modified in various obvious aspects without departing from the teachings and scope of the present disclosure. Accordingly, the drawings and descriptions are to be considered illustrative and not limiting. Additional features and advantages of the disclosure are set forth in part in the foregoing description and will be apparent in part from the description or may be inferred from the embodiments of the disclosure.

What is claimed is:

1. An optical element mount comprising a rim having an opening configured such that an optical element can be radially inserted into the mount.

2. The mount according to claim 1, wherein the edge is arranged with at least one radially acting element for fixing the optical element.

3. The mount according to claim 1, wherein the radially acting element is a spring element or a contour.

4. The mount according to claim 3, wherein the contours are selected from the group comprising wedges, half shells, cylinders, stops and balls.

5. The mount according to claim 1, wherein the edge has a notch for positioning the optical element in the axial direction.

6. The mount according to claim 1, wherein the edge surrounds the optical element in an annular or rectangular shape.

7. The mount according to claim 1, wherein the notch is formed as a C- or U-shaped profile.

8. The mount according to claim 1, wherein the spring part of the radially acting element is a shaped spring, strip spring, flat spring, leaf spring, spiral spring, barrel spring or ring spring.

9. The mount according to claim 1, comprising contours in the C- or U-shaped profile to increase the contact area between the optical element and the mount.

10. The mount according to claim 1, wherein a round mount encloses the optical element by 180° to 240°.

11. The mount according to claim 1, wherein the mount has an asymmetrical shape in cross-section for receiving the optical element.

12. The mount according to claim 1, comprising sliding elements to facilitate the insertion of the optical element.

13. The mount according to claim 12, wherein the sliding elements consist of polyamide, polytetrafluoroethylene or polyethylene.

14. A first system, comprising a mount according to claim 1 and an optical element for insertion into the mount.

15. The first system according to claim 14, wherein the optical element is surrounded by a mount.

16. A second system, comprising a first system according to claim 14 and a device for receiving the mount.

17. The second system according to claim 16, wherein it is a lens tube.

18. A laser processing head for laser material processing comprising a second system according to claim 16.

19. A second system, comprising a first system according to claim 15 and a device for receiving the mount.

20. The second system according to claim 19, wherein it is a lens tube.

21. A laser processing head for laser material processing comprising a second system according to claim 19.
